(19) United States
(12) Patent Application Publication
(10) Pub. No.: US 2010/0038915 A1
(43) Pub. Date: Feb. 18, 2010

(54) MAGNUS TYPE WIND POWER GENERATOR

(76) Inventor: Nobuhiro Murakami, Akita (JP)

Correspondence Address: HAYES SOLOWAY P.C., 3450 E. SUNRISE DRIVE, SUITE 140, TUCSON, AZ, 85718, US

(21) Appl. No.: 12/522,538

(22) PCT Filed: Feb. 6, 2008
(86) PCT No.: PCT/JP2008/051940

§ 371 Date: Jul. 8, 2009

(30) Foreign Application Priority Data
Jun. 29, 2007 (JP) 2007-171709

(51) Int. Cl. F03D 9/00; F03D 5/00

(52) U.S. Cl. 290/55

(57) ABSTRACT

A Magnus-type wind power generator in which rotary columns rotate about the axes of the rotary columns, whereby a horizontal rotary shaft is rotated by Magnus lift that occurs due to interaction of wind power with the rotation of the rotary columns, and a power generating mechanism is driven. An external peripheral surface of the rotary columns has a structure in which spiral ribs formed in a convex shape are provided, and a flow component (V) of air at least parallel to the axes of the rotary columns is generated on the external peripheral surfaces of the rotary columns by the spiral ribs. The spiral ribs are formed so that a lead angle (θ) thereof is smaller at a distal end of the rotary columns than at a proximal end of the rotary columns near the horizontal rotary shaft.

### TECHNICAL FIELD

The present invention relates to a Magnus-type wind power generator for rotating a horizontal rotary shaft through the use of Magnus lift generated by the interaction of wind power and the rotation of rotary columns, and driving a power generating mechanism, and to a control method for the Magnus-type wind power generator.

### BACKGROUND ART

In a conventional Magnus-type wind power generator, a required number of rotary columns are provided in radial fashion to a horizontal rotary shaft, and the rotary columns are caused to rotate about the axes thereof by driving a driving motor, and when natural wind strikes the rotating rotary columns, the horizontal shaft is rotated by lift that occurs due to a Magnus effect brought about by the interaction of the wind power with the rotation of the rotary columns, and electrical power is generated by transmitting the rotation of the horizontal shaft to a power generator. In this type of Magnus-type wind power generator, a large amount of energy is consumed to rotate the rotary columns at high speed, and the power generating efficiency is poor (see Patent Document 1, for example).

Therefore, a Magnus-type wind power generator has been proposed in which spiral ribs are integrally formed in spiral fashion on the external peripheral surfaces of the rotary columns along the entire length in the longitudinal direction of the rotary columns in the Magnus-type wind power generator, and air flow is generated on the external peripheral surfaces of the rotary columns by the spiral ribs separately from the movement of air on the surface layers of the rotary columns that occurs due to natural wind or the rotation of the rotary columns. The Magnus lift is thereby increased, and the power generating efficiency of the wind power generator is markedly increased throughout the range from low wind speed to relatively high wind speed (see Patent Document 2, for example).

Patent Document 1: U.S. Pat. No. 4,366,386 Specification

Patent Document 2: International Laid-open Patent Application No. 2007/17930 Pamphlet

### DISCLOSURE OF THE INVENTION

### Problems to Be Solved by the Invention

However, in the Magnus-type wind power generator disclosed in Patent Document 2, although the Magnus lift can be increased by providing spiral ribs to the rotary columns, the spiral ribs are formed so that the tilt angle (lead angle) thereof is uniform along the entire length in the longitudinal direction of the rotary columns, and when the rotary columns rotate about the horizontal rotary shaft, a larger air flow strikes the distal-end regions of the rotary columns than the proximal-end regions, and the wind pressure applied to the spiral ribs increases. There is therefore a tendency for the air resistance applied to the spiral ribs to increase, which results in increased energy consumption to rotate the rotary columns about the axes thereof, and the power generating efficiency of the Magnus-type wind power generator is not adequately increased.

The present invention was developed in view of the foregoing drawbacks, and an object of the present invention is to provide a Magnus-type wind power generator capable of reducing the effects of wind resistance applied to the spiral ribs in the distal-end regions of the rotary columns, and enhance power generating efficiency.

In order to overcome the aforementioned drawbacks, the Magnus-type wind power generator according to a first aspect of the present invention is a Magnus-type wind power generator comprising a horizontal rotary shaft for transmitting a rotation torque to a power generating mechanism; and a required number of rotary columns arranged in substantially radial fashion from the horizontal rotary shaft; wherein the rotary columns rotate about axes of the rotary columns, whereby the horizontal rotary shaft is rotated by Magnus lift that occurs due to interaction of wind power with rotation of the rotary columns, and the power generating mechanism is driven; and the Magnus-type wind power generator is characterized in that an external peripheral surface of the rotary columns has a structure in which a spiral rib formed in a convex shape is provided, and a flow component of air at least parallel to the axes of the rotary columns is generated on the external peripheral surfaces of the rotary columns by the spiral ribs; and the spiral ribs are formed so that a lead angle of the spiral ribs is smaller at a distal end of the rotary columns than at a proximal end of the rotary columns near the horizontal rotary shaft.

According to this aspect, when the rotary columns are rotated about the horizontal rotary shaft, the peripheral velocity of the distal ends of the rotary columns is greater than the peripheral velocity of the proximal ends thereof, and the distal ends of the rotary columns in this state meet with a faster flow of air than the proximal ends. Therefore, since the spiral ribs are formed so that the lead angles thereof are smaller at the distal ends of the rotary columns than at the proximal ends thereof, the aforementioned air flow does not significantly resist the spiral rigs in the regions of the distal ends of the rotary columns, the energy consumption involved in rotating the rotary columns about the axes thereof is prevented from increasing, and the power generating efficiency of the Magnus-type wind power generator can be enhanced.

The Magnus-type wind power generator according to a second aspect of the present invention is the Magnus-type wind power generator according to the first aspect, characterized in that a maximum lead angle of the spiral ribs at the proximal ends of the rotary columns is substantially 45 degrees, and the lead angle of the spiral ribs decreases to less than substantially 45 degrees towards the distal ends of the rotary columns.

According to this aspect, the inventors learned as a result of investigative experimentation the appropriateness of setting the maximum lead angle of the spiral ribs to substantially 45 degrees and decreasing the lead angle to less than substantially 45 degrees towards the distal ends of the rotary columns.

The Magnus-type wind power generator according to a third aspect of the present invention is the Magnus-type wind power generator according to the first or second aspect, characterized in that at least two regions including a proximal-end region of the rotary columns and a distal-end region of the rotary columns are provided to the rotary columns, and the lead angles of the spiral ribs are each a constant lead angle within each the region.

According to this aspect, during manufacturing of the Magnus-type wind power generator, a spiral rib having a constant lead angle that differs in each region of a rotary column may be formed, and manufacturing of a rotary column provided with a spiral rib is facilitated.

The Magnus-type wind power generator according to a fourth aspect of the present invention is the Magnus-type wind power generator according to the third aspect, characterized in that at least three regions including a proximal-end region of the rotary columns, a central region of the rotary columns, and a distal-end region of the rotary columns are provided to the rotary columns.

According to this aspect, by dividing the rotary columns into three or more regions, substantially the same effects can be obtained as when spiral ribs are formed in which the lead angle gradually changes through each region of a rotary column.

### BRIEF DESCRIPTION OF THE DRAWINGS

FIG. 1 is a diagram showing Magnus lift;

FIG. 2 is a front view showing the Magnus-type wind power generator in Example 1;

FIG. 3 is a side view showing the Magnus-type wind power generator;

FIG. 4 is a front view showing a rotary column provided with spiral ribs;

FIG. 5 is an A-A sectional view showing the rotary column in FIG. 4;

FIG. 6 is a diagram showing the air flow striking the rotary column;

FIG. 7 is a graph showing the relationship between wind speed and output when the conventional spiral ribs are used, and when the spiral ribs of Example 1 are used;

FIG. 8 is an enlarged sectional view showing a spiral rib in Example 2;

FIG. 9 is an enlarged sectional view showing a spiral rib in Example 3; and

FIG. 10 is a sectional view showing the spiral ribs in Example 4.

### KEY

1 Magnus-type wind power generator

3 power generating mechanism

5 rotary body (horizontal rotary shaft)

7 rotary column

7′ external peripheral surface

8a, 8b, 8c spiral ribs

8c″, 8c′ spiral ribs

8c′″ spiral rib

10 outer shaft (horizontal rotary shaft)

15 generator

24 control circuit

25 base member (flexible member)

26 coating (surface material)

27 first base member (flexible member)

28 second base member (flexible member)

### BEST MODE FOR CARRYING OUT THE INVENTION

Preferred embodiments for implementing the Magnus-type wind power generator according to the present invention will be described hereinafter based on examples.

### Example 1

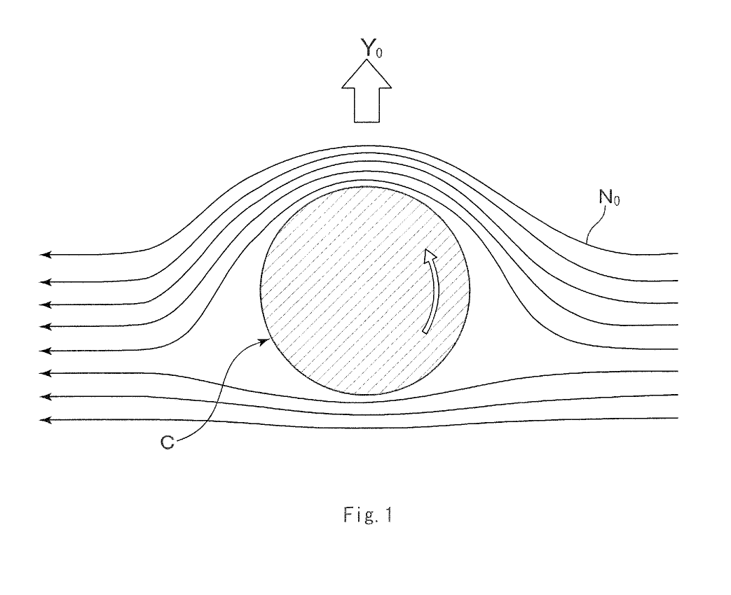

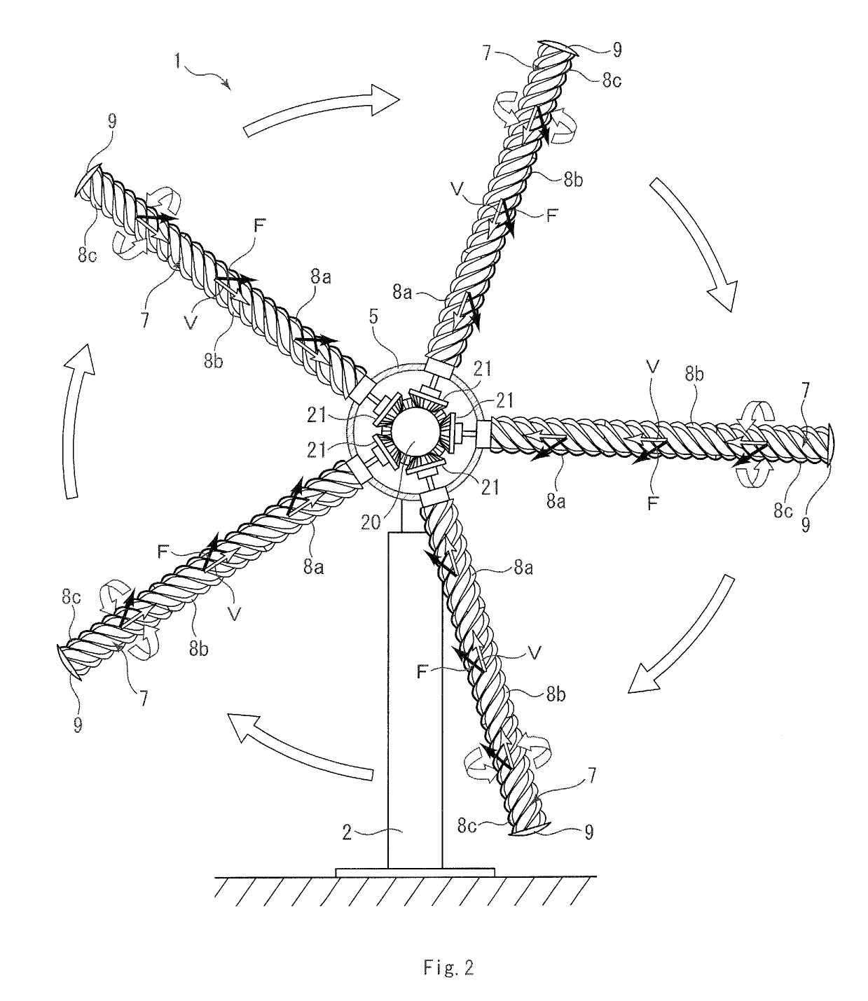

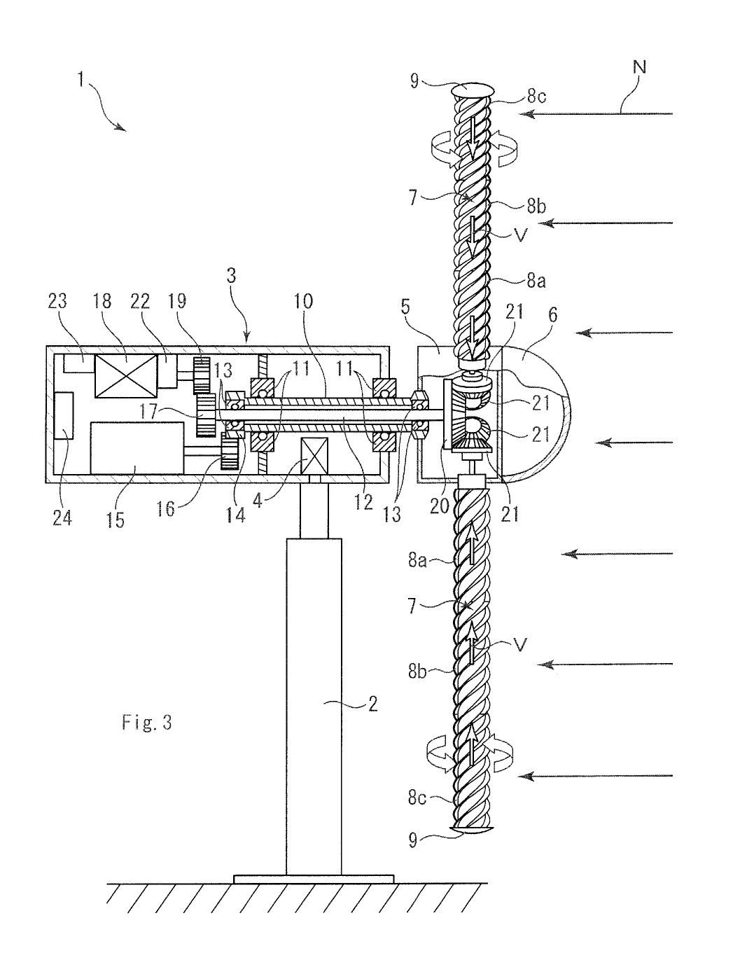

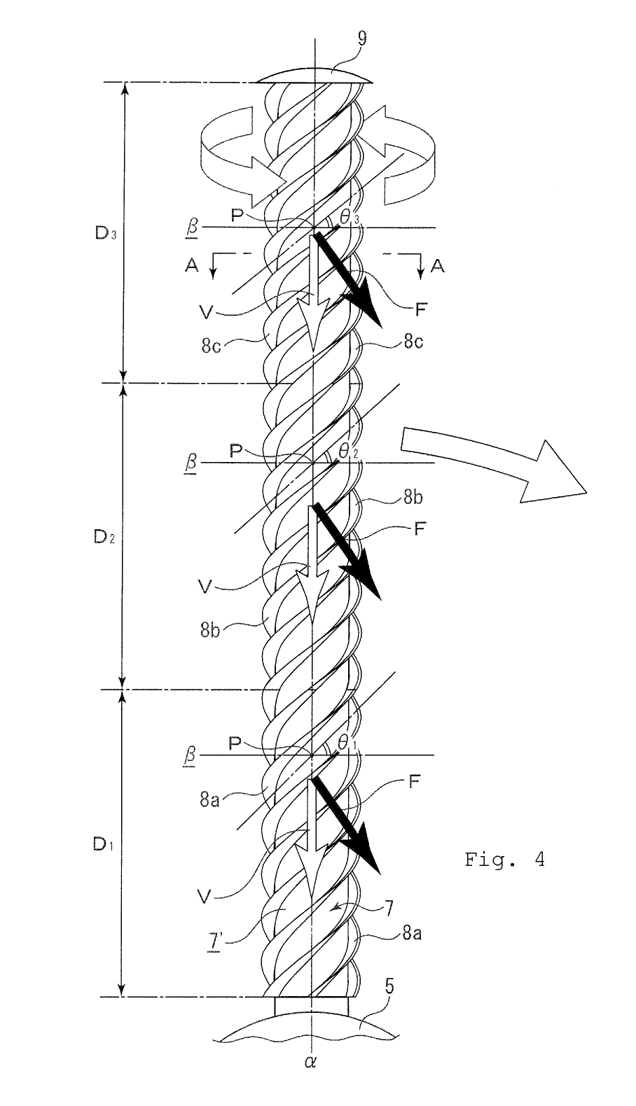

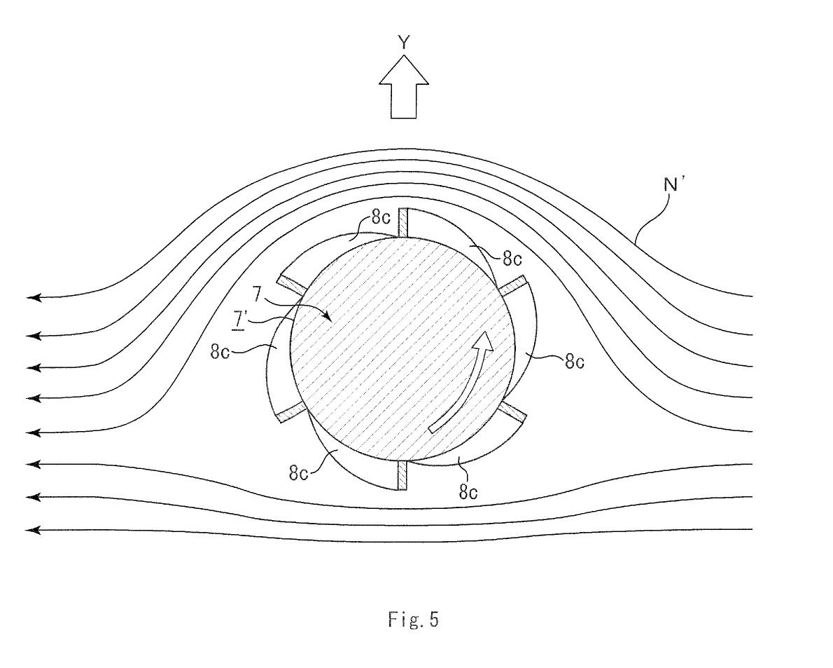

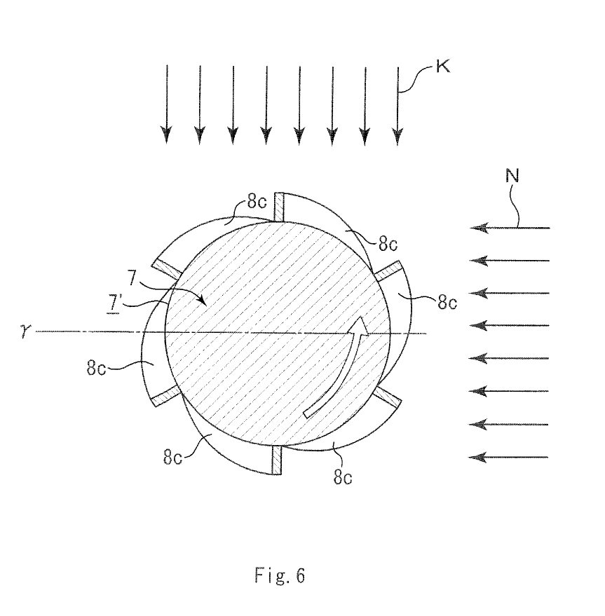

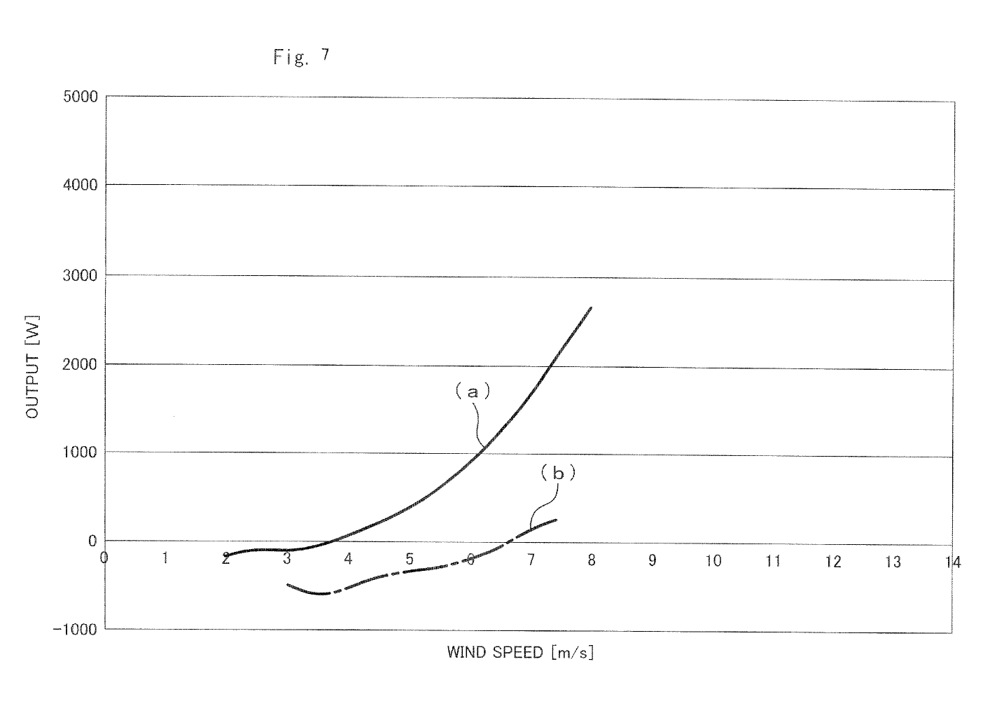

An example of the present invention will be described based on the drawings. FIG. 1 is a diagram showing Magnus lift; FIG. 2 is a front view showing the Magnus-type wind power generator in Example 1; FIG. 3 is a side view showing the Magnus-type wind power generator; FIG. 4 is a front view showing a rotary column provided with spiral ribs; FIG. 5 is an A-A sectional view showing the rotary column in FIG. 4; FIG. 6 is a diagram showing the air flow striking the rotary column; and FIG. 7 is a graph showing the relationship between wind speed and output when the conventional spiral ribs are used, and when the spiral ribs of Example 1 are used. In the description given hereinafter, the side in front of the paper surface in FIGS. 2 and 4 is the front side (forward side) of the Magnus-type wind power generator, and the right-hand side of the paper surface in FIGS. 3, 5, and 6 is the front side (forward side) of the Magnus-type wind power generator.

In a common mechanism for generating Magnus lift, as shown in the sectional view of the rotary column C having a cylindrical shape as shown in FIG. 1, a flow of air against the rotating rotary column C flows upward along with the rotation of the rotary column C when the flow of air is in the direction of the air flow No in the rotation direction (left rotation) of the rotary column C such as shown in FIG. 1, and since the air flowing toward the top of the rotary column C at this time flows faster than the air flowing below the rotary column C, a Magnus effect occur in which there is a difference in air pressure between the negative pressure of the upper side and the positive pressure of the lower side of the rotary column C, and a Magnus lift Y₀ is generated in the direction perpendicular to the air flow N₀ on the rotary column C.

The reference numeral 1 in FIGS. 2 and 3 indicates a Magnus-type wind power generator to which the present invention is applied. The Magnus-type wind power generator 1 has a power generation mechanism 3 supported so as to be able to turn in the horizontal direction by the top part of a support base 2 erected on the ground surface, and the power generation mechanism 3 can turn in the horizontal direction through the driving of an internally housed vertical motor 4.

As shown in FIGS. 2 and 3, a rotary body 5 as a horizontal rotary shaft in the present example having an rotational axis in the horizontal direction is disposed in front of the power generation mechanism 3, and the rotary body 5 is supported so as to rotate clockwise as viewed from the front, as shown in FIG. 2. A front fairing 6 is attached to the front side of the rotary body 5, and five substantially cylindrical rotary columns 7 are arranged in radial fashion on the external periphery of the rotary body 5. Each of the rotary columns 7 is supported so as to be able to rotate in a predetermined rotation direction about the axis of the respective rotary column 7.

As shown in FIG. 4, spiral ribs 8a, 8b, 8c formed in a spiral (helical) shape are integrally formed in coiled fashion along the entire length of the rotary column 7 from the proximal end to the distal end thereof on the external peripheral surface 7′ of the rotary column 7, and the spiral ribs 8a, 8b, 8c are formed in a substantially convex shape that protrudes from the external peripheral surface 7′ of the rotary column 7. Six of the convex spiral ribs 8a, 8b, 8c are formed on the external peripheral surface 7′ of one rotary column 7.

The rotary column 7 is formed so that the diameter thereof is the same from the proximal end to the distal end, and a disk-shaped end cap 9 having a larger diameter than the rotary column 7 is attached to the proximal end surface of the rotary column 7.

The spiral ribs 8a, 8b, 8c forming a sixfold helix having the required width and height are provided along the entire length in the longitudinal direction of the rotary column 7, and are fixed so as to form a clockwise helix in a right-hand screw shape as viewed from the distal end of the rotary column 7 (see FIG. 5).

In the present example, the spiral ribs 8a, 8b, 8c are formed by polycarbonate or another relatively rigid synthetic resin material. The spiral ribs 8a, 8b, 8c may also be fabricated by a lightweight alloy or other material having weather resistance and durability.

As shown in FIG. 3, an outer shaft 10 as the horizontal rotary shaft in the present example whose longitudinal direction is oriented horizontally is disposed inside the power generation mechanism 3, and the outer shaft 10 is supported so as to be able to rotate in the vertical direction via bearings 11 disposed inside the power generation mechanism 3. The inside of the outer shaft 10 is hollow, and an inner shaft 12 is inserted through the inside of the outer shaft 10.

The inner shaft 12 shown in FIG. 3 is supported so as to be able to rotate in the vertical direction via bearings 13 disposed within the outer shaft 10. The outer shaft 10 and the inner shaft 12 can rotate independently of each other.

As shown in FIG. 3, a gear 14 is fixed to the rear end of the outer shaft 10, and the gear 14 meshes with a gear 16 that is connected to a generator 15 in the power generation mechanism 3. The rotary body 5 is fixed to the front end of the outer shaft 10 so as to protrude to the outside of the power generation mechanism 3.

As shown in FIG. 3, a gear 17 that protrudes from the outer shaft 10 is fixed to the rear end of the inner shaft 12, and the gear 17 meshes with a gear 19 that is coupled to a driving motor 18 in the power generation mechanism 3. The front end of the inner shaft 12 protrudes from the outer shaft 10, and a large-diameter bevel gear 20 is fixed to the front end of the inner shaft 12.

A one-way clutch 22 for transmitting the rotary power of the driving motor 18 in one direction is disposed between the driving motor 18 and the gear 19 shown in FIG. 3, and even when rotary force in the reverse direction is applied to the driving motor 18 through the rotation of the gear 19, the driving motor 18 can be prevented from rotating in reverse by the one-way clutch 22. Furthermore, a battery 23 for storing electrical power for starting the driving motor 18 is disposed inside the power generation mechanism 3. The vertical motor 4 and the driving motor 18 are controlled by a control circuit 24 that is connected to an anemoscope (not shown) or an anemometer (not shown) for monitoring the wind direction or wind speed of the environment surrounding the Magnus-type wind power generator 1.

As shown in FIG. 2, the large-diameter bevel gear 20 fixed to the inner shaft 12 is disposed in the center of the inside of the rotary body 5 fixed in front of the outer shaft 10, and the large-diameter bevel gear 20 is positioned so as to close in the forward direction. Furthermore, five small-diameter bevel gears 21 are meshed with the large-diameter bevel gear 20, and the five small-diameter bevel gears 21 are connected to the proximal parts of the five rotary columns 7 arranged on the external periphery of the rotary body 5.

When the driving motor 18 in the power generation mechanism 3 shown in FIG. 3 is driven, the power of the driving motor 18 is transmitted to the large-diameter bevel gear 20 via the inner shaft 12, the five small-diameter bevel gears 21 meshed with the large-diameter bevel gear 20 are rotated, and the five rotary columns 7 connected to the bevel gears 21 are rotated about the axes of the rotary columns 7.

During power generation using the Magnus-type wind power generator 1, the wind direction is first detected by the anemoscope (not shown), the control circuit 24 activates the vertical motor 4, and the power generation mechanism 3 is turned in accordance with the wind direction so that the wind occurs from the front of the rotary body 5. Natural wind N then strikes the Magnus-type wind power generator 1 from the front side thereof, as shown in FIG. 3.

The activation electrical power stored in the battery 23 inside the power generation mechanism 3 is then fed to the driving motor 18, and the driving motor 18 is driven. The drive force of the driving motor 18 is transmitted via the inner shaft 12 and the bevel gears 20, 21, and the rotary columns 7 begin to rotate. The rotary columns 7 and the rotary body 5 are rotated about the outer shaft 10 by Magnus lift Y created by the interaction of wind power with the rotation of the rotary columns 7.

The rotation direction of the rotary columns 7 and the manner in which the spiral ribs 8a, 8b, 8c are wound will be described in detail with reference to FIG. 5. When the spiral ribs 8a, 8b, 8c of the rotary column 7 are wound so as to form a clockwise helix in a right-hand screw shape as viewed from the distal end of the rotary column 7, the rotary column 7 rotates in the left direction. Since the winding direction of the spiral ribs 8a, 8b, 8c is the opposite of the rotation direction of the rotary column 7, air flowing on the external peripheral surface 7′ of the rotary column 7 can flow in the direction of approaching the rotary body 5, as shown in FIGS. 2 and 4.

As shown in FIG. 4, the spiral ribs 8a, 8b, 8c are provided to the rotary column 7, whereby an air flow F is generated by the spiral ribs 8a, 8b, 8c when the rotary column 7 rotates. An air flow component V (vector component V) parallel to the axis of the rotary column 7 can then be generated on the external peripheral surface 7′ of the rotary column 7, separately from the natural wind N or the movement of air on the surface layer of the rotary column 7 that rotates in conjunction with the rotary column 7. As shown in FIG. 2, this air flow component V flows toward the rotary body 5 (the proximal ends of the rotary columns 7) from the distal ends of the rotary columns 7.

As shown in FIGS. 4 and 5, by generating an air flow on the external periphery of the rotary column 7, i.e., by generating the air flow F on the external peripheral surface 7′ of the rotary column 7, a three-dimensional air flow is formed by the natural wind N (air flow N′) and the movement of air on the surface layer of the rotary column 7 that rotates in conjunction with the rotary column 7.

As shown in FIG. 5, the Magnus lift Y created by the interaction of wind power with the rotation of the rotary columns 7 is increased. The air flows F provided by the spiral ribs 8a, 8b, 8c referred to herein are not necessarily oriented in the direction parallel to the axes of the rotary columns 7, and adequate effects are obtained insofar as there is at least a vector component V parallel to the axes of the rotary columns 7. According to one speculation by the inventors, the reason for the increase in Magnus lift Y may be an increase in the pressure difference between the negative pressure and positive pressure applied to the rotary columns 7, an increase in the size of the lift-generating surface, or another phenomenon.

When the end caps 9 are utilized, the Magnus effect is enhanced. Specifically, by providing the end caps 9 to the distal-end surfaces of the rotary columns 7, the end caps 9 have a favorable effect on the air flows F, and enhanced Magnus lift Y is observed.

As shown in FIG. 3, when the rotary body 5 rotates, the generator 15 connected to the rear end of the outer shaft 10 is driven, and electricity is generated. Furthermore, since the air flow in the axial direction of the rotary columns 7 due to the spiral ribs 8a, 8b, 8c increases based on the rotation of the rotary columns 7, the Magnus lift Y of the rotary columns 7 is increased, and the rotational torque of the outer shaft 10 for driving the generator 15 is increased. Consequently, the power generating efficiency of the Magnus-type wind power generator 1 can be increased.

When power generation by the generator 15 is started, a portion of the generated electrical power can be fed to the driving motor 18 for rotating the rotary columns 7 and used as auxiliary electrical power, and can also be stored in the battery 23 as electrical power for the next startup.

The convex spiral ribs 8a, 8b, 8c used by the Magnus-type wind power generator 1 of the present example will next be described in detail. First, as shown in FIG. 5, the shape of the spiral ribs 8a, 8b, 8c is substantially rectangular as viewed in cross-section, and the spiral ribs 8a, 8b, 8c are formed so as each to have the same cross-sectional shape along the entire length of the spiral ribs 8a, 8b, 8c in the longitudinal direction.

In the spiral ribs 8a, 8b, 8c in the present example, the protrusion length from the external peripheral surface 7′ of the rotary column 7 to the upper ends of the spiral ribs 8a, 8b, 8c is substantially about 20 mm, and the spiral ribs 8a, 8b, 8c are formed so as to have the same protrusion length along the longitudinal direction. The protrusion length of the spiral ribs 8a, 8b, 8c may also be within the range of substantially 10 mm or more and substantially 60 mm or less.

The width of the spiral ribs 8a, 8b, 8c in the present example is substantially about 10 mm, and the spiral ribs 8a, 8b, 8c are formed so as to have the same width along the longitudinal direction. The width of the spiral ribs 8a, 8b, 8c may also be within the range of substantially 3 mm or more and substantially 30 mm or less.

As shown in FIG. 4, the spiral ribs 8a, 8b, 8c are provided to the rotary column 7 in a state in which the lead angles θ₁, θ₂, θ₃ thereof are tilted at substantially 40 to 45 degrees. In the present example, the angles formed by the spiral ribs 8 and planes β that are at right angles to a central axis α of the rotary column 7 and passing through arbitrary points P on the spiral ribs 8a, 8b, 8c are referred to as the lead angles θ₁, θ₂, θ₃.

In the present example, spiral ribs 8a, 8b, 8c are provided that have three types of different lead angles θ₁, θ₂, θ₃, in which the spiral rib 8a has a 45-degree lead angle θ₁, the spiral rib 8b has a 42.5-degree lead angle θ₂, and the spiral rib 8c has a 40-degree lead angle θ₃. The rotary column 7 can also be divided into three regions in sequence from the side near the rotary body 5, which include the region D₁ of the proximal end, the region D₂ of the central portion, and the region D₃ of the distal end.

As shown in FIGS. 4 and 5, the spiral rib 8a having the 45-degree lead angle θ₁ is provided at equal intervals on the cross-sectional periphery of the rotary column 7 in the region D₁ of the proximal end in the rotary column 7. The spiral rib 8b having the 42.5-degree lead angle θ₂ is provided at equal intervals on the cross-sectional periphery of the rotary column 7 in the region D₂ of the central portion in the rotary column 7. The spiral rib 8c having the 40-degree lead angle θ₃ is also provided at equal intervals on the cross-sectional periphery of the rotary column 7 in the region D₃ of the distal end in the rotary column 7.

The spiral ribs 8a, 8b, 8c are formed with constant lead angles θ₁, θ₂, θ₃ within the regions D₁, D₂, D₃ in which the respective spiral ribs 8a, 8b, 8c are provided. Specifically, the spiral rib 8a is formed at the constant lead angle θ₁ in the region D₁ of the proximal end of the rotary column 7; the spiral rib 8b is formed at the constant lead angle θ₂ in the region D₂ of the central portion of the rotary column 7; and the spiral rib 8c is formed at the constant lead angle θ₃ in the region D₃ of the distal end of the rotary column 7.

By forming the spiral ribs 8a, 8b, 8c in this manner so that the lead angles θ₁, θ₂, θ₃ thereof are smaller in the region D₃ at the distal end than in the region D₁ at the proximal end of the rotary column 7, the direction in which the spiral rib 8c extends in the region D₃ of the distal end of the rotary column 7 approaches the direction parallel to the flow direction of the air flow N′, and the air resistance applied to the spiral rib 8c can be reduced. The flow direction of the air flow N′ referred to in the present example is the direction substantially parallel to the planes β shown in FIG. 4.

More specifically, when the rotary column 7 is rotated about the rotary body 5, the air flow N′ striking the rotary column 7 shown in FIG. 5 is the air flow N′ that is the synthesis of the natural wind N and the air flow K received by the rotary column 7 from the rotation direction thereof. When the rotary column 7 is rotated about the rotary body 5, the peripheral velocity of the distal end of the rotary column 7 is greater than the peripheral velocity of the proximal end, and the speed of the air flow N′ received by the rotary column 7 in this state is such that the air flow N′ received by the distal end of the rotary column 7 is faster than the air flow N′ received by the proximal end of the rotary column 7.

The peripheral velocity in the present example is the speed proportional to the rotational speed of the rotary column 7 and the distance from the rotary body 5 at the center of rotation when the rotary column 7 is rotated about the rotary body 5, and the peripheral velocity is higher at the distal end of the rotary column 7 than at the proximal end thereof. Therefore, in the spiral ribs 8a, 8b, 8c of the present example, the lead angle θ₃ is small in the spiral rib 8c in the region D₃ at the distal end of the rotary column 7, where a high-wind-speed air flow N′ easily occurs.

More specifically, as shown in FIG. 6, there is the natural wind N occurring from the front side of the rotary column 7, and the air flow K occurring from the rotation direction when the rotary column 7 is rotated about the axis γ at the center of the rotary body 5. Since the air flow K occurring from the rotation direction of the rotary column 7 is fast particularly in the region D₃ of the distal end of the rotary column 7, the air resistance received from the air flow K occurring from the rotation direction of the rotary column 7 is effectively reduced by reducing the lead angle θ₃ of the spiral rib 8c in the region D₃ of the distal end of the rotary column 7.

The results of investigative experimentation with the lead angles θ of the spiral ribs by the inventors will next be described in detail. FIG. 7 is a graph showing the relationship between the wind speed [m/s] and the output [W], for comparing the Magnus-type wind power generator 1 to which the spiral ribs 8a, 8b, 8c of the present example are provided and a Magnus-type wind power generator to which conventional spiral ribs are provided. The net output [W] referred to herein is the electrical power obtained when the electrical power used for driving the driving motor 18 is subtracted from the electrical power generated by the Magnus-type wind power generator 1.

The lead angle θ of the conventional spiral rib used in the present experiment is substantially 45 degrees, and the lead angle θ is formed so as to be the same from the proximal end to the distal end of the rotary column. Furthermore, the conventional spiral rib is formed so that structural conditions other than the lead angle θ are all the same.

The graph (a) in FIG. 7 is a graph showing the relationship between the wind speed [m/s] and the output [W] of the Magnus-type wind power generator 1 to which the spiral ribs 8a, 8b, 8c of Example 1 are provided, and the graph (b) is a graph showing the relationship between the wind speed [m/s] and the output [W] of a Magnus-type wind power generator to which a conventional spiral rib is provided.

As shown in FIG. 7, when the graph (a) of the Magnus-type wind power generator 1 using the spiral ribs 8a, 8b, 8c of Example 1 is compared with the graph (b) of the Magnus-type wind power generator provided with the conventional spiral rib, it is apparent that the value of the output [W] in the graph (a) of the Magnus-type wind power generator 1 of Example 1 is higher than the value of the output [W] in the graph (b) of the conventional Magnus-type wind power generator at all wind speeds.

As is also apparent from the results of the experiment described above, even when the wind speed [m/s] state is considered, it is apparent that the power generating efficiency can be most effectively increased by forming a small lead angle θ₃ in the spiral rib 8c provided to the region D₃ of the distal end of the rotary column 7 in the practical Magnus-type wind power generator 1.

In the Magnus-type wind power generator 1 in the present example, the lead angle θ₃ of the spiral rib 8c provided to the region D₃ of the distal end is smaller than in the region D₁ of the proximal end of the rotary column 7, whereby the air flow N′ (air flow K) does not create significant resistance against the spiral rib 8c in the region D₃ of the distal end of the rotary column 7, the amount of energy consumed to rotate the rotary column 7 about the axis thereof does not increase, and the power generating efficiency of the Magnus-type wind power generator 1 can be enhanced. It is not necessary for the direction in which the spiral rib 8c extends to be perfectly parallel to the flow direction of the air flow N′, and to at least approach the parallel direction is sufficient.

As a result of investigative experimentation, it is apparent that a suitable configuration is to set the maximum lead angle θ₁ of the spiral rib 8a of the proximal end of the rotary column 7 to substantially 45 degrees, and for the lead angles θ₂, θ₃ of the spiral ribs 8b, 8c to become less than substantially 45 degrees towards the distal end of the rotary column 7.

The spiral ribs 8a, 8b, 8c include spiral ribs 8a, 8b, 8c having lead angles θ of substantially 45 degrees or less, whereby the lead angles θ of substantially 45 degrees or less can reduce the air resistance applied to the spiral ribs 8a, 8b, 8c when the rotary column 7 is rotated about the rotary body 5.

Furthermore, when the lead angles θ of the spiral ribs 8a, 8b, 8c are large, although the air flow component V parallel to the axis of the rotary column 7 increases when the rotary column 7 is rotated about the axis thereof, the air resistance applied to the spiral ribs 8a, 8b, 8c increases, and the amount of energy consumed to rotate the rotary column 7 about the axis thereof increases, i.e., the amount of electrical power consumed to drive the driving motor 18 increases. The lead angles θ of the spiral ribs 8a, 8b, 8c are therefore preferably set to substantially 45 degrees or less.

The three regions including the region D₁ of the proximal end of the rotary column 7, the region D₂ of the central portion of the rotary column 7, and the region D₃ of the distal end of the rotary column 7 are provided to the rotary column 7, and the lead angles θ of the spiral ribs 8a, 8b, 8c are each a constant lead angle θ within the respective region D thereof. Spiral ribs 8a, 8b, 8c each having a different constant lead angle θ for each region D of the rotary column 7 may thereby be formed when the Magnus-type wind power generator 1 is manufactured, and manufacturing of the rotary column 7 to which the spiral ribs 8a, 8b, 8c are provided is facilitated. Furthermore, by dividing the rotary column 7 into three or more regions D, substantially the same effects can be obtained as when spiral ribs are formed in which the lead angle θ gradually changes through each region D of the rotary column 7.

### Example 2

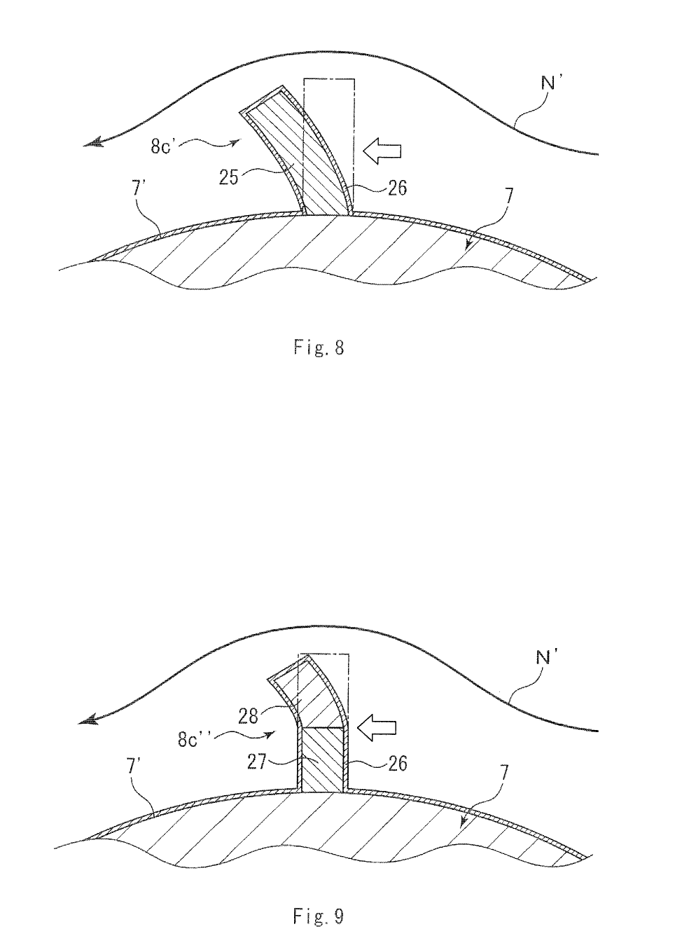

The spiral rib 8c′ according to Example 2 will next be described with reference to FIG. 8. The same reference symbols are used for constituent elements that are the same as those described in the previously described example, and no redundant descriptions will be given. FIG. 8 is an enlarged sectional view showing the spiral rib 8c′ in Example 2. The upper side on the paper surface in the spiral rib 8c′ shown in FIG. 8 will be described hereinafter as the upper end (distal end) of the spiral rib 8c′.

As shown in FIG. 8, when the spiral rib 8c′ in Example 2 is provided to the external peripheral surface 7′ of the rotary column 7, a base member 25 formed by polyethylene foam or another elastic flexible member is first fixed to the external peripheral surface 7′ of the rotary column 7 by an adhesive. The base member 25 is substantially in the form of a sponge (porous body) whose interior is porous. In the present example, polyethylene foam is used as the material of the base member 25, but urethane foam or another material may also be used. Furthermore, the base member 25 of the present embodiment is at least more elastic than the rigid rotary column 7.

The compression stress (deformation 25%) of the base member 25 of the spiral rib 8c′ used in the present example is substantially about 140 kPa. It is sufficient if the compression stress of the base member 25 of the spiral rib 8c′ is within the range of substantially 20 kPa or higher and substantially 500 kPa or lower. Furthermore, the term “compression stress” in the present example refers to the stress that occurs within the member as resistance when the member is subjected to a compressing load.

The apparent density of the base member 25 of the spiral rib 8c′ used in the present example is substantially 65 kg/m³. It is sufficient if the apparent density of the base member 25 of the spiral rib 8c′ is within the range of substantially 25 kg/m³ or higher and substantially 250 kg/m³ or lower.

An acrylic urethane resin coating material having elasticity and moisture resistance is applied so as to continuously cover the base member 25 of the spiral rib 8c′ and the external peripheral surface 7′ of the rotary column 7, and a coating 26 as a surface material is formed on the entire surface of the spiral rib 8c′ and the rotary column 7. Furthermore, the elasticity (extension coefficient) of the coating material used in the present example is substantially about 320%. It is sufficient if the elasticity of the coating material used in the present example is within the range of substantially 10% or higher and substantially 1000% or lower. Furthermore, an acrylic urethane resin coating material is used to form the coating 26 in the present example, but a vinyl coating material, a silicone resin coating material, a fluororesin coating material, or the like may also be used.

As shown in FIG. 8, the spiral rib 8c′ flexes so that the upper end part thereof tilts downstream of the spiral rib 8c′ when the relatively high-speed air flow N′ strikes the rotary column 7. The spiral rib 8c′ flexed by the air flow N′ is returned to the original shape by the elasticity of the base member 25 and the centrifugal force due to rotation of the rotary column 7.

The spiral rib 8c′ is thus easily flexed by the air flow N′ at a high wind speed, and there is therefore no risk of the rotary column 7 being excessively rotated by the high-speed air flow N′ against the spiral rib 8c′ on the lift-generating side of the rotary column 7, which becomes a tailwind with respect to the spiral rib 8c′, and a load being placed on the driving motor 18, or of the rotation of the rotary column 7 being resisted by a high-speed air flow N′ against the spiral rib 8c′ on the non-lift-generating side of the rotary column 7, which becomes a headwind with respect to the spiral rib 8c′.

The spiral rib 8c′ on the non-lift-generating side of the rotary column 7 is easily flexed when struck by a relatively high-speed air flow N′ in comparison to the lift-generating side of the rotary column 7. Adopting such a configuration makes it possible to effectively generate an air flow F on the external peripheral surface 7′ of the rotary column 7 through the use of the spiral rib 8c′ on the lift-generating side of the rotary column 7, which is not as easily flexed as the non-lift-generating side, while reducing the air resistance applied to the spiral rib 8c′ on the non-lift-generating side of the rotary column 7.

### Example 3

The spiral rib 8c″ according to Example 3 will next be described with reference to FIG. 9. The same reference symbols are used for constituent elements that are the same as those described in the previously described examples, and no redundant descriptions will be given. FIG. 9 is an enlarged sectional view showing the spiral rib 8c′ in Example 3. The upper side on the paper surface in the spiral rib 8c″ shown in FIG. 9 will be described hereinafter as the upper end (distal end) of the spiral rib 8c″.

As shown in FIG. 9, when the spiral rib 8c″ in Example 3 is provided to the region D₃ of the distal end of the rotary column 7, a first base member 27 formed by polycarbonate or another relatively rigid synthetic resin material is first attached to the external peripheral surface 7′ of the rotary column 7 by an adhesive. A second base member 28 formed by a substantially spongiform polyethylene foam or other elastic flexible member is also fixed to the convex end surface of the first base member 27 by an adhesive.

Specifically, in the spiral rib 8c″ in Example 3, the proximal end bonded to the rotary column 7 is formed by the rigid first base member 27, and the upper end of the spiral rib 8c″ is formed by the elastic second base member 28.

Furthermore, an acrylic urethane resin coating material having elasticity and moisture resistance is applied so as to continuously cover the first base member 27 and second base member of the spiral rib 8c″, and the external peripheral surface 7′ of the rotary column 7, and a coating 26 (surface material) is formed on the entire surface of the spiral rib 8c″ and the rotary column 7.

### Example 4

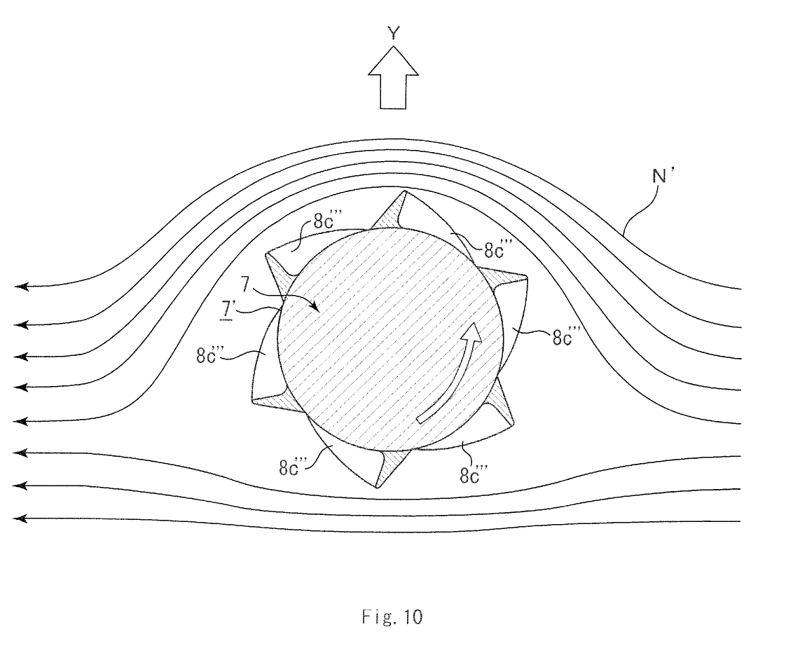

The spiral rib 8c″ according to Example 4 will next be described with reference to FIG. 10. The same reference symbols are used for constituent elements that are the same as those described in the previously described examples, and no redundant descriptions will be given. FIG. 10 is a sectional view showing the spiral ribs 8c′″ in Example 4.

As shown in FIG. 10, the spiral ribs 8c′″ in Example 4 are substantially fin shaped as viewed in cross-section. Specifically, the cross-sectional shape of the spiral ribs 8c′″ is formed so as to reduce the air resistance that occurs when the rotary column 7 rotates in the predetermined rotation direction about the axis thereof.

In Example 4, the spiral rib 8c′″ is formed by polycarbonate or another relatively rigid synthetic resin material throughout all the regions of the rotary column 7. The spiral rib 8c′″ may also be fabricated using a lightweight alloy or other material having weather resistance and durability.

Examples of the present invention were described above using the drawings, but specific configurations are not limited to these examples, and the present invention includes modifications and additions within a scope not departing from the essence of the present invention.

For example, in Example 1, the lead angles θ₁, θ₂, θ₃ of the spiral ribs 8a, 8b, 8c are constant lead angles θ₁, θ₂, θ₃ in the regions D₁, D₂, D₃, respectively, of the rotary column 7, but the present invention is not limited to this configuration, and the lead angle θ of a spiral rib provided along the entire longitudinal direction of the rotary column 7 may be formed so as to gradually decrease from the proximal end of the rotary column 7 to the distal end.

The lead angles θ₁, θ₂, θ₃ of the spiral ribs 8a, 8b, 8c were also substantially 40 to 45 degrees in Example 1, but the lead angles θ₁, θ₂, θ₃ of the spiral ribs 8a, 8b, 8c may also be within the range of substantially 30 to 55 degrees.

In Example 1, the spiral ribs 8a, 8b, 8c were also formed so that the protrusion length thereof was the same along the longitudinal direction of the spiral ribs 8a, 8b, 8c, but the protrusion length of the spiral ribs 8a, 8b, 8c may also gradually increase from the proximal end near the rotary body 5 of the rotary column 7 to the distal end of the rotary column 7. Such a configuration makes it possible to efficiently create an air flow F that includes an air flow component V parallel to the axis of the rotary column through the use of the spiral rib 8c having a large protrusion length in the region D₃ of the distal end of the rotary column 7, which has a high peripheral velocity and experiences a large amount of air flow.

In Example 2, after the base member 25 is bonded to the external peripheral surface 7′ of the rotary column 7, the coating material is applied, and the coating 26 is formed as a surface material, but the surface material is not limited to the coating 26. For example, after the base member 25 is bonded to the external peripheral surface 7′ of the rotary column 7, the rotary column 7 may be inserted in a heat-shrinking tube formed by a material that is shrunk by heating, and by heating and shrinking the heat-shrinking tube, the surface material may be formed by the heat-shrinking tube.

### INDUSTRIAL APPLICABILITY

The Magnus-type wind power generator of the present invention can be applied from large-scale wind power generation to small-scale wind power generation for household use, and contributes significantly to the wind power generation industry. Furthermore, the movement efficiency of a vehicle may also be enhanced by utilizing the Magnus-type lift-generating mechanism of the present invention in a rotor vessel, rotor vehicle, or the like.

1. A Magnus-type wind power generator comprising:
a horizontal rotary shaft for transmitting a rotation torque to a power generating mechanism; and
a required number of rotary columns arranged in substantially radial fashion from the horizontal rotary shaft; wherein
the rotary columns rotate about axes of the rotary columns, whereby said horizontal rotary shaft is rotated by Magnus lift that occurs due to interaction of wind power with rotation of the rotary columns, and said power generating mechanism is driven; said Magnus-type wind power generator characterized in that
an external peripheral surface of said rotary columns has a structure in which a spiral rib formed in a convex shape is provided, and a flow component of air at least parallel to the axes of the rotary columns is generated on the external peripheral surfaces of said rotary columns by the spiral ribs; and
said spiral ribs are formed so that a lead angle of the spiral ribs is smaller at a distal end of said rotary columns than at a proximal end of said rotary columns near said horizontal rotary shaft.

2. The Magnus-type wind power generator according to claim 1, characterized in that a maximum lead angle of the spiral ribs at the proximal ends of said rotary columns is substantially 45 degrees, and the lead angle of the spiral ribs decreases to less than substantially 45 degrees towards the distal ends of said rotary columns.

3. The Magnus-type wind power generator according to claim 1, characterized in that at least two regions including a proximal-end region of the rotary columns and a distal-end region of the rotary columns are provided to said rotary columns, and the lead angles of said spiral ribs are each a constant lead angle within each said region.

4. The Magnus-type wind power generator according to claim 3 characterized in that at least three regions including a proximal-end region of the rotary columns, a central region of the rotary columns and a distal-end region of the rotary columns are provided to said rotary columns.

5. The Magnus-type wind power generator according to claim 2, characterized in that at least two regions including a proximal-end region of the rotary columns and a distal-end region of the rotary columns are provided to said rotary columns, and the lead angles of said spiral ribs are each a constant lead angle within each said region.

6. The Magnus-type wind power generator according to claim 5, characterized in that at least three regions including a proximal-end region of the rotary columns, a central region of the rotary columns, and a distal-end region of the rotary columns are provided to said rotary columns.
